(19) United States
(12) Patent Application Publication
(10) Pub. No.: US 2024/0189181 A1
(43) Pub. Date: Jun. 13, 2024

(54) REFLEXOLOGY DEVICE

(71) Applicant: Eliyahu Avihod, Jerusalem (IL)

(72) Inventor: Eliyahu Avihod, Jerusalem (IL)

(21) Appl. No.: 18/079,893

(22) Filed: Dec. 13, 2022

(51) Int. Cl. A61H 39/04

(52) U.S. Cl. CPC A61H 39/04; A61H 2201/0192; A61H 2205/065; A61H 2205/125

(57) ABSTRACT

Disclosed herein is a passive reflexology device including a rigid support, and at least one reflexology massage node mounted onto the rigid support and protruding therefrom, having at least one force concentrating edge adapted to apply a focused resistive force to a discrete portion of tissue of an extremity of a user when pushed against the at least one edge.

### FIELD OF THE INVENTION

The present disclosure generally relates to reflexology devices.

### BACKGROUND

Reflexology is a healing art that utilizes the application of pressure, particularly to the foot, each portion of which is known to correspond to a different limb or organ of the body. Using this knowledge, skilled practitioners have traditionally been able to produce a therapeutic effect elsewhere in a specific part of the body.

It is an accepted principle in reflexology that toxins accumulate in the feet, primarily acids and calcium, that can crystallize around the nerve endings. This crystallization impairs the function of nerve endings in the feet, therefore impairing the function of the organ/gland/tissue to which the nerve endings in specific portions of the feet correspond. Reflexology massage consists of the massaging of discrete points on the surface of the foot, normally requiring the dexterity, the focused touch and the application of force, as appropriate, by the fingers of a skilled practitioner. The knowledge of a practitioner includes an ability to locate discrete, tender, highly specific portions of the foot, each corresponding to a specific organ, as mentioned, such tenderness being caused by crystallized deposits or encrustations around nerve endings at those locations. Subsequently, these crystallized deposits are dispersed by focused application of a massage force to the specific location or locations, thereby to restore normal nerve function and thus providing a healing effect. Stimulating an area that does not necessarily have crystallized deposits can also stimulate a natural healing/balancing response in the correlating region of the body.

The lymphatic system is a network of channels and glands that helps defend against infections by carrying immune cells throughout the human body and by removing excess fluid. The lymphatic system works directly with the cardiovascular system to keep blood and lymphatic fluid levels in balance, and to flush toxins out of the body. When lymphatic circulation slows down it can cause fluids that normally carry waste away from the cells to become trapped and stagnant in certain areas of the body. The toxins start to accumulate and the delivery of immune cells to the areas of the body where they are needed is also impeded, thereby compromising the body's ability to fight infection and disease. Reflexology healing provides stimulation to body organs so as to maintain healthy lymphatic circulation. Reflexology for Lymphatic Drainage (“RLD”) is a technique which focuses on the lymphatic reflexes in the feet in order to stimulate the function of the lymphatic system and eliminate excess of lymph fluid thus reducing the risk of infections.

A non-negligible additional benefit of reflexology is stress reduction which positively contributes to maintaining a healthy immune system. Furthermore, reflexology boosts the production of endorphins which are needed by immune cells receptors to function properly. A healthy immune system is critical for protecting the body against disease causing organisms such as viruses and bacteria.

### SUMMARY

The following embodiments and aspects thereof are described and illustrated in conjunction with systems, tools and methods which are meant to be exemplary and illustrative, not limiting in scope.

There is provided, in accordance with an embodiment a passive reflexology device including a rigid support, and at least one reflexology massage node mounted onto the rigid support and protruding therefrom, having one or more force concentrating edges adapted to apply a focused resistive force to a discrete portion of tissue of an extremity of a user when pushed against the one or more edges.

In some embodiments, the at least one reflexology massage node includes a plurality of nodes arranged in a predetermined spatial distribution relative to the rigid support.

In some embodiments, the predetermined spatial distribution of the plurality of reflexology massage node facilitates simultaneous application of focused resistive force onto a plurality of discrete portions of tissue of the user.

In some embodiments, the predetermined spatial distribution of the at least one reflexology massage node facilitates simultaneous application of focused resistive forces to at least two extremities of the user.

In some embodiments, the plurality of reflexology massage nodes includes at least two reflexology massage nodes having predetermined different dimensions so as to facilitate applying at least two independent focused resistive forces to two different discrete portions of tissue.

In some embodiments, the at least one reflexology massage node has a predetermined height above the rigid support to facilitate generating a focused resistive force to the subcutaneous nerve endings, of varying magnitude.

In some embodiments, the predetermined height of the at least one reflexology massage node is adjustable.

In some embodiments, the reflexology massage node includes a node shape predetermined to facilitate application of a corresponding compressive force having a predetermined pressure distribution on the subcutaneous nerve endings.

In some embodiments, the passive reflexology device further includes an orientation apparatus for positioning the support and thus the reflexology massage node in a preselected orientation relative to the user.

In some embodiments, the passive reflexology device further includes a node orientation apparatus configured to modify an angle of the reflexology massage node relative to the user.

In some embodiments, the plurality of reflexology massage nodes includes a number of the reflexology massage nodes in an arrangement having a spatial distribution over an area corresponding to the area of a complete extremity of a user, and wherein the support is configured to support the number of nodes in the arrangement.

In some embodiments, the spatial distribution is suitable for a predetermined one of the following groups: left extremity; and a right extremity.

In some embodiments, the passive reflexology device further includes connections means for connecting the device to an additional passive reflexology device forming a left and right pair of the devices.

In some embodiments, the plurality of reflexology massage nodes includes a number of the reflexology massage nodes in an arrangement having a spatial distribution over an area corresponding to the area of a pair of extremities of a user, and the support is configured to support the number of reflexology massage nodes in the arrangement.

In some embodiments, the one or more force concentrating edges have a transverse dimension of no more than 16 mm.

In addition to the exemplary aspects and embodiments described above, further aspects and embodiments will become apparent by reference to the figures and by study of the following detailed description.

### BRIEF DESCRIPTION OF THE DRAWINGS

Some non-limiting exemplary embodiments or features of the disclosed subject matter are illustrated in the following drawings.

FIG. 1 is a schematic illustration of a plurality of reflexology massage nodes mounted onto a rigid support, according to certain exemplary embodiments;

FIG. 2 is a schematic illustration of a plurality of reflexology massage nodes mounted onto a rigid support, according to certain exemplary embodiments;

FIGS. 3A-3B are schematic illustrations of an embodiment of a reflexology massage node, according to certain exemplary embodiments;

FIGS. 4A-4D are schematic illustrations of variously configured reflexology massage nodes, according to certain exemplary embodiments;

FIG. 5 is a schematic illustration of an adjustable passive reflexology device for a pair of extremities, according to certain exemplary embodiments;

FIG. 6 is a schematic illustration of a pair of connectable single extremity passive reflexology devices, according to certain exemplary embodiments;

FIG. 7 is a schematic illustration of the passive reflexology device of FIG. 5 including a therapeutic cover, useful for the application of an increased resistive force to a discrete portion of tissue, according to certain exemplary embodiments;

FIGS. 8A-8C are schematic illustrations of the application of a resistive force to nerve endings within tissue of an extremity, according to certain exemplary embodiments;

FIG. 9 is a schematic illustration of adjustable reflexology massage nodes, according to certain exemplary embodiment; and

FIG. 10 is a schematic illustration showing use of the device of FIG. 5.

Identical, duplicate, equivalent or similar structures, elements, or parts that appear in one or more drawings are generally labeled with the same reference numeral, optionally with an additional letter or letters to distinguish between similar entities or variants of entities, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views. References to previously presented elements are implied without necessarily further citing the drawing or description in which they appear.

### DETAILED DESCRIPTION

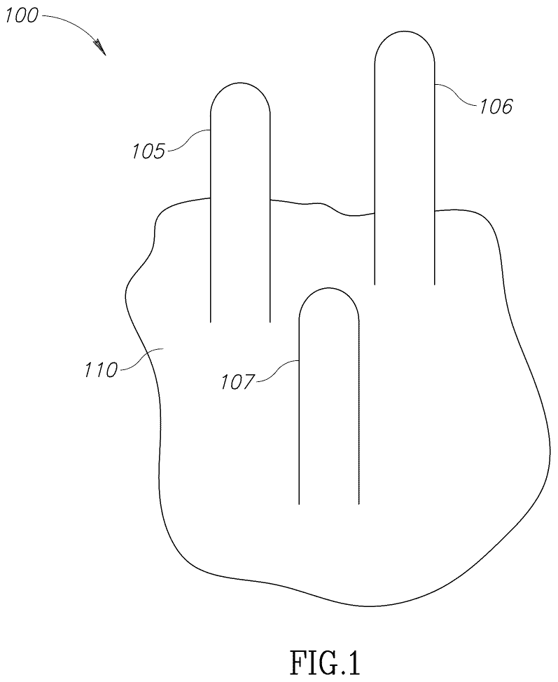

Disclosed herein is a passive reflexology device, according to certain exemplary embodiments. Reference is now made to FIG. 1, in which is illustrated an array 100 of reflexology massage nodes, designated 105, 106, 107, mounted onto a rigid support 110. Reflexology treatment as known in the art requires the application of a compressive force to a discrete portion of tissue, generally as described hereinabove.

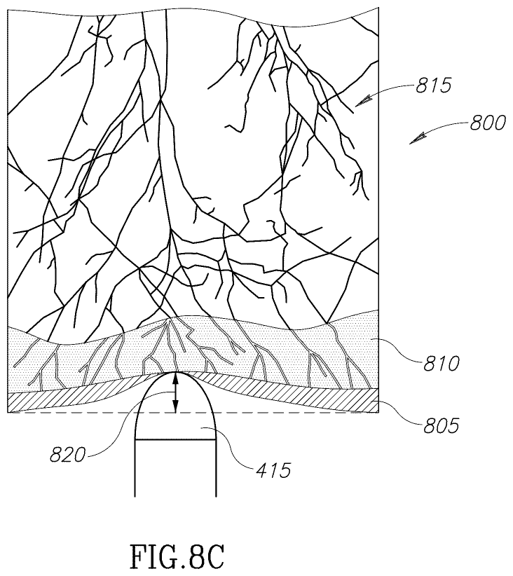

Accordingly, each reflexology node of the array 100 has dimensions predetermined to facilitate application of a specific force level to a discrete portion of tissue 800 (FIG. 8A) of a user when the user presses his or her extremity, such as a foot or a hand, for example, against the node. Such force, caused by the application of a force by a user to the node, is referred to herein as a ‘resistive’ force. In general, the extremity to which reference is made herein is the foot, although it is intended to apply equally to the hand. It will also be appreciated that the specificity of such force level is not an absolute measured force, rather, it is a subjective force experienced by a user as being ‘tolerable discomfort’, beyond which the discomfort would not be tolerable and thus is equivalent to a maximum resistive force.

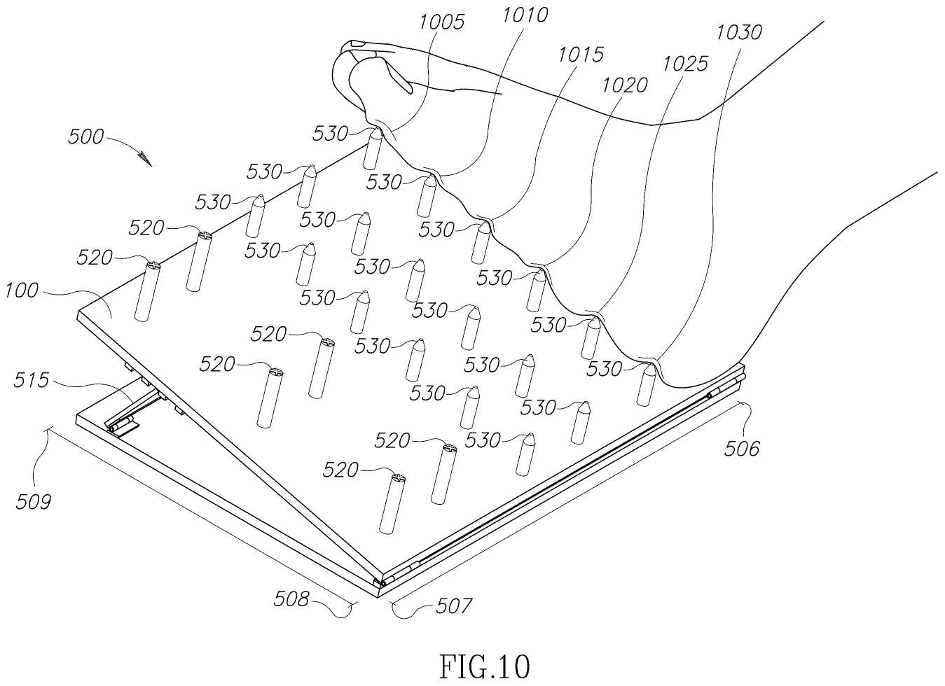

In use, as described below, and as exemplified in FIG. 10, a user moves his or her foot, against a selected node, varying the location and intensity of pushing force until feeling a therapeutic discomfort or pressure at a discrete portion of tissue, as would be felt during treatment by a reflexologist. In the present invention, however, the user is able to control his treatment by instant, direct biofeedback and is therefore in full control at all times. As known, the above-mentioned therapeutic discomfort is caused by the application thereto of a focused resistive force which stimulates subcutaneous nerve endings 815 (FIG. 8A) of tissue 800 of the extremity. This causes the disintegration of crystallized deposits that have accumulated in the subcutaneous nerve endings 815 at that tissue portion, so as to restore proper function thereto, and thus also to associated organs in the body of the user.

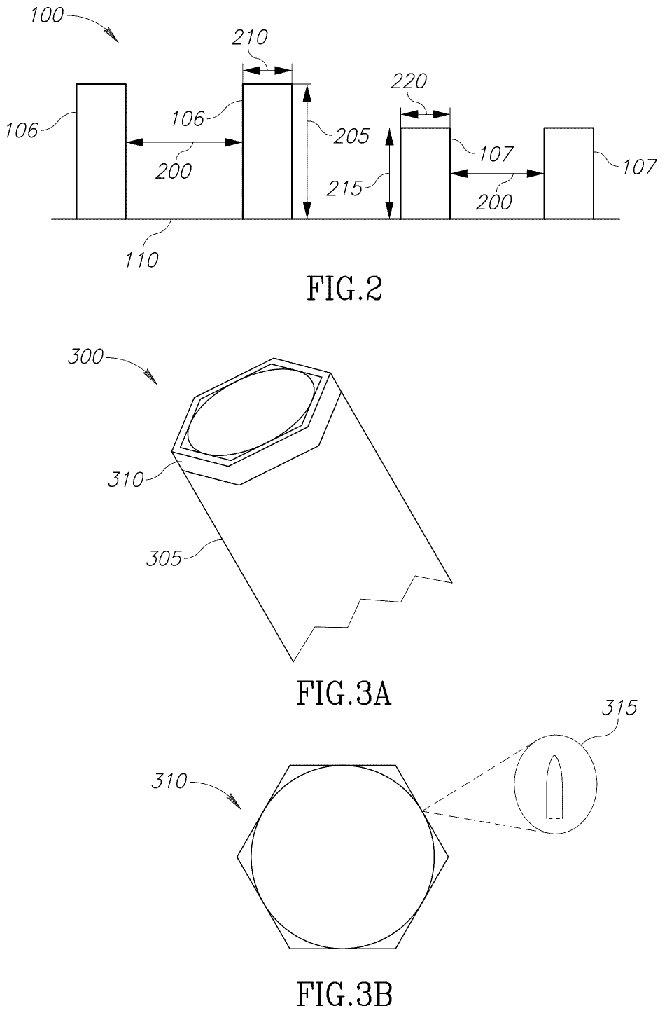

As seen in FIG. 2, reflexology nodes 106 and 107 are arranged in array 100 in predetermined linear spatial distributions, as indicated by dimensions referenced 200, and having transverse dimensions 210, along rigid support 110. The predetermined spatial distribution and dimensions are predetermined so as to provide sufficient distance between each reflexology massage node 106, 107 to facilitate access of extremity tissue portions 800 (FIG. 8A) to one or more desired nodes so as to enable application thereby of a desired focused resistive force. In some embodiments, the predetermined spatial distributions 200, 210 facilitate administration of multiple focused resistive forces onto a plurality of discrete portions of tissue 800 (FIG. 8A) by enabling each reflexology node to apply an independent focused resistive force to a separate discrete portion of tissue 800, as selected by the user, as described in conjunction with FIG. 10 herein.

In some embodiments, array 100 can include a plurality of reflexology nodes including two or more groupings of nodes of different dimensions, such as height and width, as illustrated, and aspect ratio. For example, a first reflexology node 106 can have a first height 205 and first width 210, and a second reflexology node 107 can have a second height 215 and a second width 220. The height 205 of the reflexology node 106 can facilitate generating a predetermined magnitude of the resistive force that is applied to the discrete portion of tissue 800 as it facilitates compression of tissue pushed thereagainst to a greater depth than, for example, the shorter height 215 of nodes 107. Therefore, the provision of reflexology nodes with different heights facilitates a corresponding change in the magnitude of the focused resistive force applied to the tissue 800. Similarly, the provision of nodes of varying widths 210, 220 provides a corresponding change in the surface area of the discrete portion to which the focused resistive force is applied, causing a corresponding to an area of tissue to which the focused resistive force is applied.

It is generally accepted that the minimum width of the fingertip of a human adult is 16 millimeter (“mm”). In the present invention, therefore the transverse dimension of the edges via which a resistive force is applied to tissue is typically no more than 16 mm, and in some embodiments is less than 16 mm. It will thus be appreciated that the present invention is characterized by the ability of a user to massage his or her own foot (or other extremity) with precision which is at least as fine as facilitated by the fingers of a reflexology therapist; differently configured nodes having not only widths of different magnitudes, but also having different configurations, with different aspect ratios and different edge configurations.

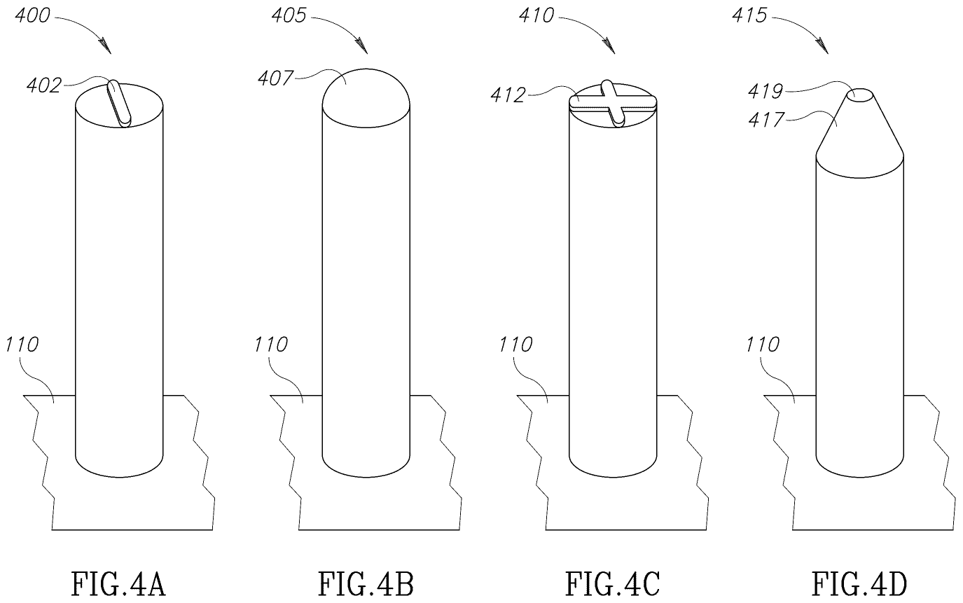

Accordingly, and with reference to FIGS. 3A-3B, there is shown a reflexology node 300 configured to have a shaft 305 connecting a node 310 to rigid support 110 (FIGS. 1 and 2). Node 310 can include one or more force concentrating edge portions 315, which are operative to provide the focused resistive force to the discrete portion of tissue 800 (FIG. 8A) along a thin, linear region whose shape corresponds to the shape of edge portions 315. It will be appreciated by persons skilled in the art that the node 310 is constructed to manipulate tissue 800 in a manner similar to that of the tip of a human finger and to apply a resistive force to tissue 800 in a corresponding manner that will break down crystallized deposits that accumulate in the subcutaneous nerve endings 815 (FIG. 8A), as described above.

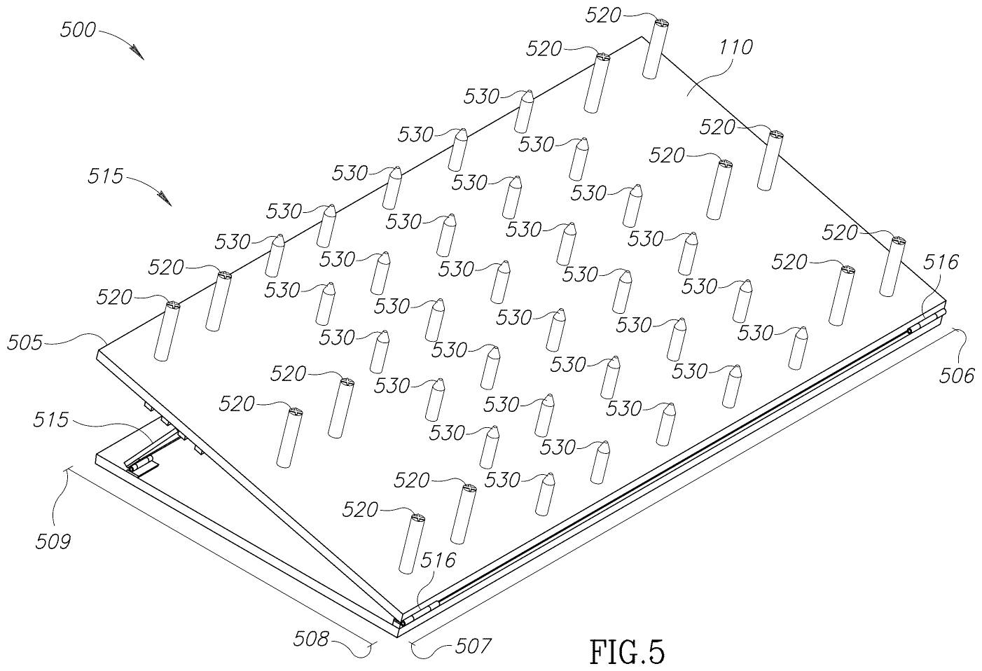

As mentioned above, the nodes can be configured differently. By way of non-limiting example, and with reference to FIGS. 4A-4D, there are shown various reflexology nodes having variously configured force concentrating edges or surfaces that can apply different focused resistive forces to tissue 800 (FIG. 8A), according to certain exemplary embodiments. Each force concentration edge or surface is operative to provide a different focused resistive force to a discrete portion of tissue 800 (FIG. 8A), thereby providing a different stimulation to the subcutaneous nerve endings 815 (FIG. 8A) and thereby facilitate the breaking down of the crystallized deposits, as above.

In particular, seen in FIG. 4A is a reflexology massage node with a force concentrating edge 400 having a typically diametrical linear protrusion 402.

FIG. 4B schematically illustrates a reflexology massage node with a rounded or hemispherically shaped surface 407.

FIG. 4C schematically illustrates a reflexology massage node with a pair of intersecting linear force concentrating protrusions 412.

FIG. 4D schematically illustrates reflexology massage node with a force concentrating portion 417 in the form of a cone. The tip 419 of the cone may be as sharp as may be effective in applying a pin-point force, while not being so sharp as to pierce the skin.

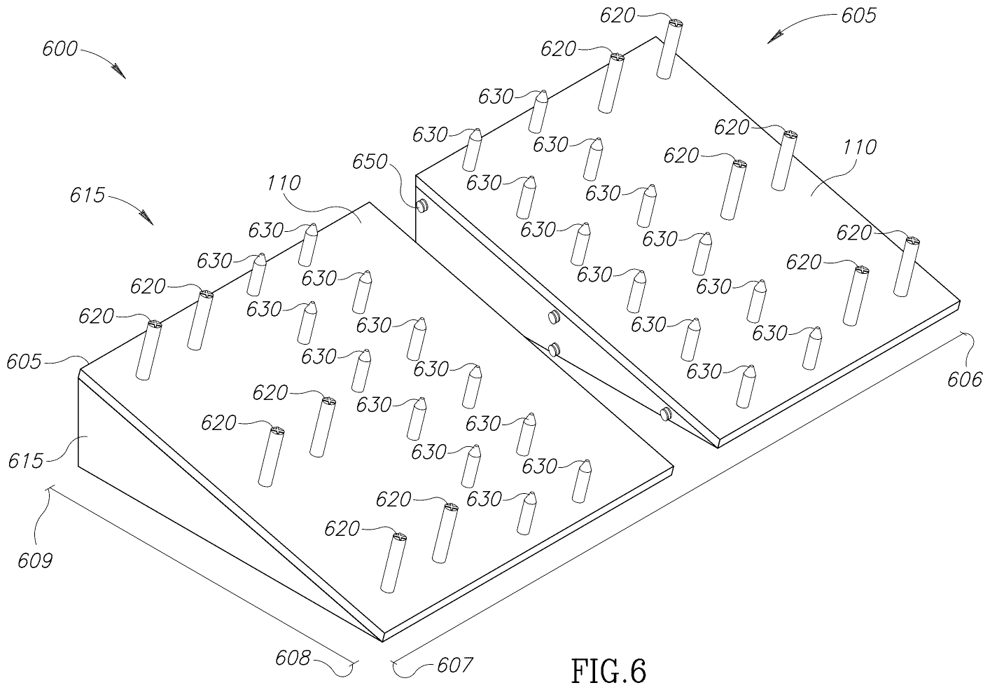

Referring now to FIG. 5, there is shown an adjustable passive reflexology device, referenced generally 500, according to certain exemplary embodiments. Device 500 includes an array of a plurality of reflexology massage nodes 520, 530 mounted onto rigid support 110. The reflexology nodes can have a predetermined spatial distribution that facilitates application of the focused resistive force to tissue 800 (FIG. 8A) of the extremity. There may be provided a position adjustment member 515 for allowing a user to orient rigid support 110 and thus the plurality of reflexology nodes 520, 530 relative to a hinged base member 516, as selected.

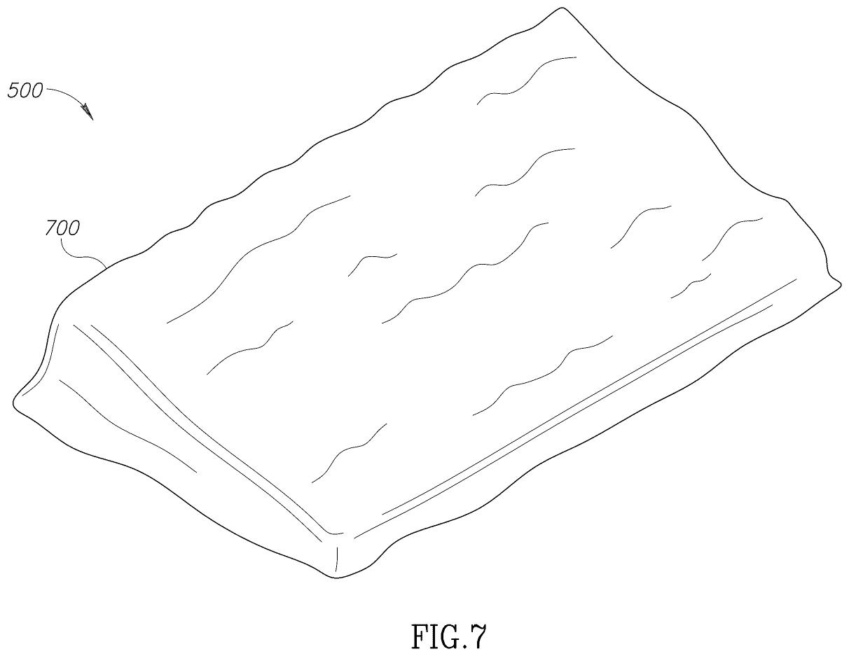

As exemplified in FIG. 6, a positioning apparatus 615 may be provided as a simple wedge, configured to orient the support 110 at an angle of 15-30 degrees relative to a support surface. In certain embodiments, the array of nodes may be mounted onto a support 110 having an area similar to that of an extremity, namely the foot or the hand, of a typical user. In one example, as seen in FIG. 6, the device may be arranged for use by a left extremity or by a right extremity. In this embodiment, the number of nodes and arrangement thereof on support 110 is particularly suitable for massaging either the complete foot or hand simultaneously. Furthermore, preferably, there are nodes of sufficient height and spacing so that so that for every discrete portion of the foot to be massaged, there is provided a plurality of nodes which is selectable by a user, regardless of the location on the foot, the ‘entry’ angle required and intensity of massage force desired.

Accordingly, and referring now specifically to FIG. 6, there is provided a pair of passive reflexology devices 600 and 605. Typically, device 600 is configured for left footed or left handed use, while device 605 is configured for right handed or right footed use. Each device is formed of a rigid support 110 on which is arranged an array of reflexology massage nodes 520 and 530, so as to accommodate the foot of a user at an angular orientation determined by a position adjustment member 515.

According to certain exemplary embodiments, devices 600 and 605 may be connected to each other by mechanical connectors 650 of any suitable type, such as snap type or magnetic connectors. When two passive reflexology devices 600, 605 are connected, a user can conveniently use devices 600 and 605 simultaneously on separate extremities, for example, on both feet or hands simultaneously.

In another embodiment, as seen in FIG. 5, device 500 may be configured as a dual use device, essentially combining device 600 and 605 but employing a single rigid support 510.

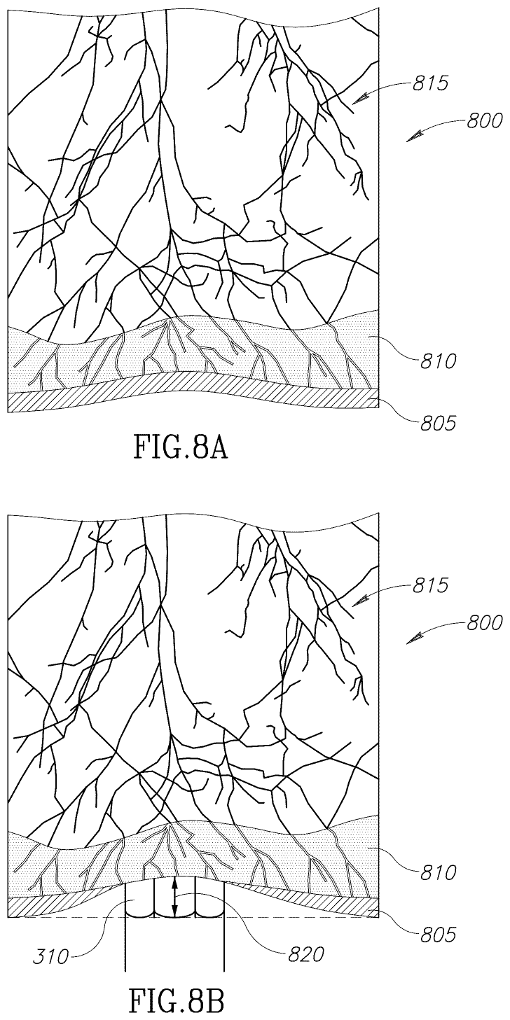

As shown and described above in conjunction with FIGS. 3A-4D, the passive reflexology massage nodes may be formed so as to apply to discrete tissue portions a resistive force that is relatively more or less concentrated, via edge portions 315. In order to mitigate potential discomfort while maximizing the resistive force that may be generated by the user, there may be provided a therapeutic cover 700, as seen in FIG. 7. Cover 700 which may be made of fabric, polymer, or other suitable material, is operative to provide padding to reflexology node thereby enabling a subject to generate a greater resistive force to a discrete portion of tissue 800 (FIG. 8A).

Reference is now made to FIGS. 8A-8C showing tissue 800 (FIG. 8A), and the application of a resistive force to nerve endings within tissue 800, according to certain exemplary embodiments, as shown in FIGS. 8B and 8C.

As seen in FIG. 8A in schematical form, the skin tissue 800 of an extremity of a user, such as a foot, includes an epidermis layer 805, a dermis layer 810 and multiple subcutaneous nerve endings which are located in the area denoted generally by reference numeral 815.

Reference is now made to FIGS. 8B and 8C, there is shown a reflexology node 300, having different end configurations, applying a resistive force to tissue 800. In more detail, in response to a user pushing against the edge portion 315 of a node 310, the edge portion applies a resistive force which compresses tissue 800 thereby applying pressure to the nerve endings, resulting in stimulation thereof and/or dispersion of crystal encrustations thereat.

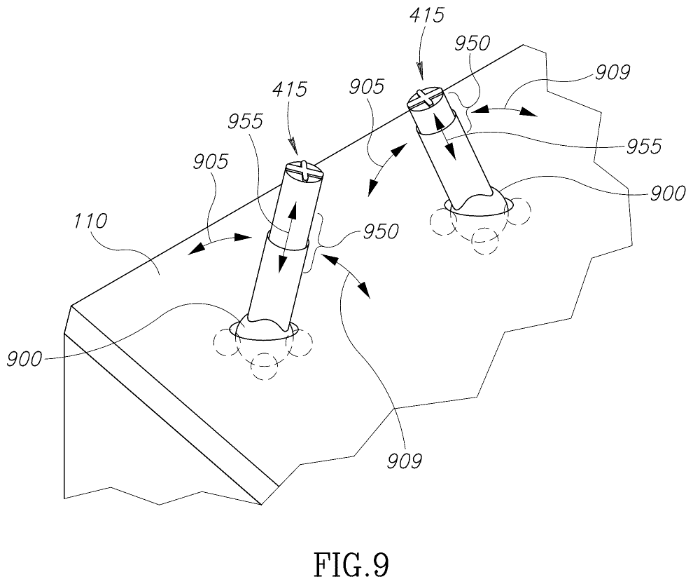

Reference is now made to FIG. 9, which shows reflexology massage nodes 415 including a node orientation apparatus 900. Node orientation apparatus 900 is configured to allow a user to position reflexology massage nodes 415 for optimal application of pressure.

In certain embodiments, reflexology massage nodes 415 can include a telescopic mechanism 950 or equivalent, for modifying their height, as illustrated by arrows 955 thereby to adjust the pressure applied thereby during use.

Referring now to FIG. 10, there is shown, by way of illustrative example only, the foot 1000 of a user when pressed onto a plurality of reflexology massage nodes 530, according to certain exemplary embodiments. As described herein in conjunction with FIG. 2, the distribution of reflexology massage nodes 530 along rigid support 110 is predetermined so as to provide sufficient distance between adjacent reflexology massage nodes 530 to facilitate simultaneous massaging thereby of a plurality of tissue portions, exemplified as 1005, 1010, 1015, 1020, 1025, 1030. Each node 530 applies a resistive force to a separate discrete portion of tissue, thereby allowing the user to simultaneously target multiple pressure points and delicate areas in foot 1000. Manipulation of the user of his or her foot causes a variation in the pressure applied to each of the different tissue portions so that while a greater resistive force is applied to one tissue portion, such as tissue portion 1005, a smaller resistive force may be applied to a second tissue portion, such as tissue portion 1020.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

As used herein the term “configuring” and/or ‘adapting’ for an objective, or a variation thereof, implies using materials and/or components in a manner designed for and/or implemented and/or operable or operative to achieve the objective.

Unless otherwise specified, the terms ‘about’ and/or ‘close’ with respect to a magnitude or a numerical value implies within an inclusive range of −10% to +10% of the respective magnitude or value.

Unless otherwise specified, the terms ‘about’ and/or ‘close’ with respect to a dimension or extent, such as length, implies within an inclusive range of −10% to +10% of the respective dimension or extent.

Unless otherwise specified, the terms ‘about’ or ‘close’ imply at or in a region of, or close to a location or a part of an object relative to other parts or regions of the object.

When a range of values is recited, it is merely for convenience or brevity and includes all the possible sub-ranges as well as individual numerical values within and about the boundary of that range. Any numeric value, unless otherwise specified, includes also practical close values enabling an embodiment or a method, and integral values do not exclude fractional values. A sub-range values and practical close values should be considered as specifically disclosed values.

As used herein, ellipsis ( . . . ) between two entities or values denotes an inclusive range of entities or values, respectively. For example, A . . . Z implies all the letters from A to Z, inclusively.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

Terms in the claims that follow should be interpreted, without limiting, as characterized or described in the specification.

1. A passive reflexology device comprising:
a rigid support; and
at least one reflexology massage node mounted onto said rigid support and protruding therefrom, having at least one force concentrating edge adapted to apply a focused resistive force to a discrete portion of tissue of an extremity of a user when pushed against said at least one edge.

2. A passive reflexology device according to claim 1, wherein said at least one reflexology massage node comprises a plurality of nodes arranged in a predetermined spatial distribution relative to said rigid support.

3. A passive reflexology device according to claim 2, wherein said predetermined spatial distribution of said nodes facilitates simultaneous application of focused resistive force onto a plurality of discrete portions of tissue of the user.

4. A passive reflexology device according to claim 2, wherein said predetermined spatial distribution of said nodes facilitates simultaneous application of focused resistive forces to at least two extremities of the user.

5. A passive reflexology device according to claim 2, wherein said plurality of nodes comprises at least two nodes having predetermined different dimensions so as to facilitate applying at least two independent focused resistive forces to two different discrete portions of tissue.

6. A passive reflexology device according to claim 1, wherein said at least one reflexology node has a predetermined height above said rigid support to facilitate generating a focused resistive force to the subcutaneous nerve endings, of varying magnitude.

7. A passive reflexology device according to claim 6, wherein said predetermined height is adjustable.

8. A passive reflexology device according to claim 1, wherein said at least one reflexology node comprises a node shape predetermined to facilitate application of a corresponding compressive force having a predetermined pressure distribution on the subcutaneous nerve endings.

9. A passive reflexology device according to claim 1, further comprising an orientation apparatus for positioning said support and thus said at least one reflexology node in a preselected orientation relative to the user.

10. A passive reflexology device according to claim 1, further comprising a node orientation apparatus configured to modify an angle of said at least one reflexology node relative to the user.

11. A passive reflexology device according to claim 2, wherein said plurality of nodes comprises a number of said nodes in an arrangement having a spatial distribution over an area corresponding to the area of a complete extremity of a user, and wherein said support is configured to support said number of nodes in said arrangement.

12. A passive reflexology device according to claim 11, wherein said spatial distribution is suitable for a predetermined one of the following group:
left extremity; and
a right extremity.

13. A passive reflexology device according to claim 12, further comprising connections means for connecting said device to an additional passive reflexology device forming a left and right pair of said devices.

14. A passive reflexology device according to claim 2, wherein said plurality of nodes comprises a number of said nodes in an arrangement having a spatial distribution over an area corresponding to the area of a pair of extremities of a user, and wherein said support is configured to support said number of nodes in said arrangement.

15. A passive reflexology device according to claim 1, wherein said at least one force concentrating edge has a transverse dimension of no more than 16 mm.
